(19) United States
(12) Patent Application Publication
(10) Pub. No.: US 2015/0379510 A1
(43) Pub. Date: Dec. 31, 2015

(54) Method and system to use a block chain infrastructure and Smart Contracts to monetize data transactions involving changes to data included into a data supply chain.

(71) Applicant: Stanley Benjamin Smith, Charlotte, NC (US)

(72) Inventor: Stanley Benjamin Smith, Charlotte, NC (US)

(21) Appl. No.: 14/852,610

(22) Filed: Sep. 13, 2015

Related U.S. Application Data
(63) Continuation of application No. 13/545,891, filed on Jul. 10, 2012.

(51) Int. Cl. G06Q 20/38; G06F 17/30

(52) U.S. Cl. CPC G06Q 20/3829; G06F 17/30368; G06Q 2220/00

(57) ABSTRACT

A method and system to use a block chain infrastructure and smart contracts to monetize data transactions involving changes to data included into a data supply chain.

The invention describes a system and method to use smart contracts to monetize changes to data using a block chain infrastructure. The system and method matches a data producer's data with a data buyer's specifications, and enables micropayments for changed data responsive to observation of changes to data included into a data supply chain on a granular level.

The implementation of block chain infrastructure for data transfer enables a new class of business methods that enables the maintenance of privacy of personal information while giving access to actionable data and implementing a fair and transparent market for data producers and data buyers to use redundant distributed ledgers of transactions on peer to peer networks.

This invention is an improvement to an issued patent, U.S. Pat. No. 8,271,346.

### BACKGROUND OF THE INVENTION

1. Field of the invention

This invention relates a system and business method for data producers to implement fees and other exchanges for changes to data included into a data supply chain through Smart Contracts linked to a block chain infrastructure.

2. Description of the related art

There have been a series of improvements to U.S. Pat. No. 7,860,760 since it was issued. In particular, U.S. Pat. No. 8,862,506 in art unit 3625 expands the data supply chain of U.S. Pat. No. 7,860,760 by establishing that a necessary and sufficient unit of value for data is a question and an answer. These are called a “Data Item Pair” (DIP) and typically consist of a row label and column label with a value component at the intersection of the row and column label. Data tables are easily convertible to a set of Data Item Pairs (DIPs). DIPs can readily be sourced from IoT devices as well as tables maintained by a data producer (such as personal medical information, commodity prices, product defects etc.). The patent (U.S. Pat. No. 8,862,506) also teaches that DIPs can be monetized by the DIP, and exchange of micropayments per DIP is taught by the invention.

U.S. Pat. No. 8,862,506 introduces art for a data producers to capture, format, and organize data from their own device as they operate them. This data, if converted into DIPs, can readily be posted to the Web by a data producer to be discovered via a search engine by a data buyer. The data buyer can confirm the value of the DIPs for his purposes before a contract to purchase is entered into. U.S. Pat. No. 8,510,176 introduces art for enabling a search for data and a handshake between a data buyer and a data producer. U.S. Pat. No. 8,560,464 anticipates charging micro-fees for use of a GUI on a granular level when a data buyer and a data producer are “clicking” through a GUI. Because Smart Contracts for DIPs and changes to DIPs can readily be linked to a block chain ledger, micropayments for use of a GUI as in U.S. Pat. No. 8,560,464 are easily implemented.

The infrastructure of the Ethereum block chain and other block chains that charge micro-fees for use of the GUI associated with them are especially friendly to micropayments and thus to monetization of data trading by the DIP and change to a DIP. A disadvantage of a block chain ledger is the latency period between the posting of data to the block chain and validation and authentication done by users of the peer to peer infrastructure. Reducing the latency period is therefore an advantage for data trading when changes to data can trigger decisions by a data buyer to leverage new information in real time. DIPs are therefore particularly friendly to block chain infrastructure requirements. Contracts between a data producer and a data buyer involving placing large datasets into the block chain infrastructure and exchanging those large data sets would clog the block chain and reduce the efficiency of the validation and authentication transactions. When a data producer and a data buyer contract to buy or sell changes to data in the form of a DIP, the only data transmitted, other than encrypted keys, is the current DIP itself.

Real time or near real time triggers for server actions and distribution of notifications about changes to data, especially if risk or business tactics are involved, have the highest business value for a data buyer. U.S. Pat. No. 7,860,760 introduced art for a method to implement a data supply chain based upon triggered server actions when a value for a data field within a data set reached a threshold value. A Smart Contract between a data buyer that enables a data buyer to access the block chain ledger and download changes to individual DIPs will leverage the art for triggering introduced in U.S. Pat. No. 7,860,760 and evolve a continuous and verifiable record of all changes to all DIPs included in a data supply chain using Smart Contracts.

Art to connect a data buyer and a data producer resulting from discovery of a potential value for data via a search engine is not the only way to facilitate a connection that can result in a Smart Contract to use block chain infrastructure to trade data. U.S. Pat. No. 8,271,346 introduces art for a data buyer to enroll a data producer (customer or user) into the data supply chain at the point of purchase of a product or service. U.S. Pat. No. 8,271,346 enrolls data producers into populating a dataset with data, via biometric identifiers, or QRCodes or other “smart” widgets. The Smart Contract that links a data buyer and a data producer is closely analogous to the “smart” widget that links data producers into a data supply chain. The advantage of the use of block chain infrastructure is the anonymizing of the data and the transactional record, the protection of privacy via encrypted keys, the permanent and time stamped record of changes to DIPs, and the verified and authenticated transactional record of the changed DIPs linked to the block chain.

Prior to the introduction of block chain technology, monetizing changes of a value for an individual data field was not cost effective. A particular advantage of a block chain is adaptability to micro-payments and thus to trading of data by individuals users of electronic devices. Data resulting from a single individual using computational electronic devices or the set of IoT electronic device owned by an individual were seldom traded individually because processing costs made data trading on a small scale not cost effective. “Big data” was the order of the day and data vendors aggregated and marketed large datasets. These large datasets would be generated by larger enterprises using centralized enterprise database software. Additionally, large internet companies would implement questionable privacy policies to get the right to collect data from users of their websites. Other actors in the data trading space would also hijack data packets being transmitted over the internet and then extract and organize the data. Prior to introduction of the block chain infrastructure with a distributed replicated ledger, data was collected by entities that housed the data and repackaged it to monetize it.

With the introduction of the infrastructure for the block chain and Smart Contracts, data can be decentralized and distributed across multiple devices in a peer to peer network, and it can be accessed and processed by the data field. Aggregation of data from multiple data producers can be readily performed by the buyer of the data, so the advantages of large datasets can continue to be realized. The block chain presents the advantage of granularity to the data trading marketplace. The data buyer and the data producer are both enabled to generate and implement contract terms in a climate of informed consent and for fair exchange. Data on the block chain can be and usually is anonymized, but for purposes of data trading and utilization of data, associating a data field with necessary and sufficient context and demographic identifiers is where the inherent value of data for business development or scientific research or risk reduction can be realized. Processes to link a data buyer to a data producer take place off the block chain. Either the data buyer or the data producer can apply existing templates or develop specific templates for context and demographic and other data fields to be implemented by Smart Contracts and encoded into the encryption keys of a DIP posted onto the block chain ledger.

The invention disclosed herein introduces art for either the data buyer or data producer to use widgets that include algorithms to generate encrypted keys to attach context and demographic data fields to values for data fields that are to be traded. Art for widgets or use of available software associated with any of current or emerging block chains, such as Ethereum's linkage to “Serpent” for generating a Smart Contract and encrypted keys, can generate keys to link the data buyer and the data producer that are enriched with demographic and other contextual data required by a data buyer to extract full value from changes to value components associated with data (DIPs). Software can also be included with a widget or set up as a standalone API or program to generate encrypted keys that contain algebraic versions of entire datasets relevant to a data buyer.

Block chain infrastructure has design constraints that function to limit or slow down the amount of data that can be posted to the block chain ledger. The smaller the amount of data, the lower the latency period between posting and verification and authentication of the data. The invention disclosed herein facilitates near real time data trading by posting very small data packets into the block chain ledger.

Because both data buyers and data producers access the block chain via their own private encrypted keys, their identities are anonymized within the block chain ledger, yet subject to the constraints of a trust network and the requirements of the Smart Contract. Privacy of personal data and information has been emerging as a widespread and pervasive problem for data transmitted and traded via the internet. The block chain, to a large extent, resolves the issue of privacy through the use of private encrypted keys accessible only to the party who is engaged in his side of the transaction unless that key is intentionally disclosed to another party. The public key that provides access to the block chain ledger for validation and authentication of both parties meeting the terms the terms of the Smart Contract, does not carry “private” information about the data being traded. Demographic or other identification information of the producer is in the data producer's private key.

Further, the invention introduces art to leverage a unique aspect of data itself. Data is most valuable to a data buyer at the moment it changes.

### SUMMARY OF THE INVENTION

The invention is a business method and system to enable the development and use of Smart Contracts to configure and manage changes to data distributed via a peer to peer network for a “data supply chain.” The data buyer and data producer use current web based architecture and systems to evaluate the context of a data source and the data included into the data source to determine which changes to which DIPs are to be traded at a fee per change in the value at the intersection of the row label and column label of a data field. This kind of granularity is one of the features of an efficient market where an informed buyer and an informed seller can enter into a viable and reliable transaction. The block chain ledger facilitates verification and authentication of each transaction according to the terms of the applicable Smart Contract.

The present invention offers a clear example of the implementation of a practical solution to a problem common to those who are skilled in the art of data exchange and utilization. While methods and systems to update data are common, business methods and systems to monetize and leverage a change to a value associated with a single data field by contracting for only that change to that data field and the necessary and sufficient context for a buyer to use that change to the data field is new art as disclosed herein.

The common approach to data monetization is to capture and aggregate data and sort it for sale to advertisers. It is a monetization process that favors large organizations and large relatively static datasets. Following the sale of the large dataset, the data vendor will commonly charge a fee for updates of the dataset as a whole. The actual data producer is often not a part of this transaction. Middlemen usually perform the brokerage function. The art of the present invention enables data producers to focus data monetization on changes to a DIP as it is generated by and upon devices owned by and accessible to the data producer or devices the data producer owns. A contract for only the necessary and sufficient “changed data” of use to a data buyer and extracted from a data source is new art offering the potential for a breakthrough in real time research and risk management.

Data sources linked via the encrypted keys to a Smart Contract that triggers processor actions on the device of the data producer upon a change in the data and posts only the anonymized changed data to the block chain to further trigger an exchange of fees for the changed data upon validation and authentication in accordance with the Smart Contract will facilitate an open and viable data trading environment and marketplace. Linking encrypted keys to a Smart Contract and generating posts of changes to a value associated with a data field into a block chain in conformance with terms of a Smart Contract is a new art for a business method.

The business system and method also includes art for the data buyer at a point of sale or at the point delivery of a service to provide a widget or to use intelligent QRCodes or RFID tags a data producer can activate or install on an internet linked device of the data producer to automate the connection of the data producer and the data buyer to a Smart Contract. A data producer can also choose to post a widget, “mini-program,” or API from his internet enabled device to an internet enabled device of a data buyer to automate the implementation of terms of a Smart Contract.

The same widget as in the preceding paragraph or a second widget or program on an internet enabled device of a data producer also, upon activation, assigns a key to post into any digital form on the electronic device and into any digital form on linked electronic devices of the data producer to automatically initiate the Smart Contract and connect to the block chain. Assignment of a key and initiation of implementation of the Smart Contract can be by decision of the data producer on a form by form basis or can be automatic if the data producer determines that automation will serve his interests. Thus, embodiments of the invention can include the necessary and sufficient identification information to tie the digital data to the data producer and accounts associated with or linked to the data producer. In embodiments where the data buyer does not have sufficient information to determine a value for the data producer's data, a widget or program on or linked the data producer's device will extract column headers and row labels to expose to a data buyer for the data buyer to determine if the data suits his needs and for him to offer a data trading or purchase contract for changes to the data. The buyer's contract terms are posted onto the block chain and the Smart Contract and messaging functions developed for the block chain infrastructure, such as Ethereum's “Counterparty” messages the device of the data producer regarding terms. The data producer then has the option of accepting, rejecting, or negotiating the terms.

Often, data is not housed on a data producer's device, but is stored in the cloud via services such as Dropbox or is tied to the block chain infrastructure by services such as Ethereum's “Storj.” In some embodiments, the acceptance of a contract by a data producer opens a real time link between the digital data store tying together the data producer, the data storage service, and the data buyer. Embodiments can also include generation of multiple encrypted keys with additional demographic and other data about the data producer to make changes to specified DIPs more marketable for the data producer if these are better tailored to the data buyer. In some embodiments the data producer and the data buyer will use a service or a platform such a qDatum, to identify data for trading.

Some embodiments include code specific to a data producer's device. For example, upon a device generating changes to a linked DIP, the included code will remind the data producer that the DIP or data form he is changing is tradeable data and give the data producer an option to withhold the change to the data. This could be particularly advantageous if the value of the changed data fluctuates due to market forces. Embodiments also will include alerting a data buyer to a transmission of data changes and enable the data buyer to disconnect from a data producer's data supply chain before the changes to the DIP is traded or posted.

In some embodiments, a data buyer is provides a widget or program to activate upon his electronic device to specify search criteria for a search algorithm or engine, such as “Dieselpoint” that, upon invocation, enables the data buyer to identify categories of data and the row labels and column headers for the data. At the point the right data for the data buyer is discovered, the data producer and the data buyer may engage in conventional internet messaging or telephonic conversations to establish terms for the trading of changes to the data and to exchange the appropriate widgets or programs or subroutines to enable both to generate and implement their part of the Smart Contracts on the block chain infrastructure.

In some embodiments a widget or program is provided to the data producer to convert data tables generated by the data producer into Data Item Pairs that carry with them the public key for the cryptographic identity of the data producer and other qualifiers for the DIPs such as the content or subject domain and the category or subcategory within the domain. These embodiments generate a set of master tables of Column Labels and Row Labels per content or subject domain and tree down to categories and subcategories of those domains in order to increase the likelihood of monetizing changes to the value components of DIPs. These master tables are posted to websites accessible to both data buyers and data producers to negotiate the value or price or fee for the original data that will be the source for changes to DIPs. An embodiment of the invention will include enabling off block chain transactions that include a transfer by the data producer to the data buyer of the “mother” dataset for the data buyer to use for his baseline calculations, analyses, forward and backward chaining, and other activities responsive to changes in his data supply chain. An embodiment that provides an incentive to the data producer and data buyer to engage one another is enabling either party or a third party to view the master tables of row labels and column labels and contract for some or all of the current data at an agreed price with the option of implementing a Smart Contract for changes to values of fields within DIPs and invoke the block chain infrastructure by mutual consent. The data buyer can review the transmitted DIP's sans the intersection of column and row values to confirm that they are properly formed and that trading in changes to them would satisfy his business objectives.

Data trading platforms, while in their infancy, can be leveraged by both data producers to post data sets for data buyers to identify and connect to. One such service is qDatum.io.

Embodiments of the invention require at least one API. APIs can be modified and combined to address requirements of any of the embodiments of the invention. One API variant will be enabled to run on a web browser and enable a data buyer to select his DIPs and extend an offer/price DIPs populated with current values to the data producer. A second API variant will run on a data producer's local device to generate an encryption key linked (keyed) to a Smart Contract and the subset of the data producer's DIPs and changes to DIPs; the monetized component. A third API variant on the data producer's local device will capture data for the data producer to categorize and post to a storage site linked to the block chain such as Ethereum's “Storj” for a search engine specialized for data discovery, such as “Dieselpoint.” A fourth API variant will be provided by a data buyer and downloadable to the device of a data producer through use of a smart QRCode, RFID tag, or other API transfer tool associated with and often physically attached to a product or service to enable a data producer to enroll and opt into a contract for data trading of changed value components in a DIP. A fifth API variant for both buyers and sellers using a social network app like “Hedgehog” (an Ethereum social network application in development) can also be invoked to establish communication, verifying that both parties are legitimate data buyers and/or data producers. Communication protocols within the social network will enable finely tuned exchange of sets of DIP's and changes to DIPs between the data buyer and the data producer. At the point that both are in consensus about the trade and the value to the data buyer of a change in the value component of a DIP, subsets of actions can adjust the terms of Smart Contract. Such subsets of actions are frequencies for updates, limits on the number of DIP changes to upload within a time window, and so forth. Those skilled in the art will understand that flexibility and variability in the provision and use of API's is a necessary part of any business method for a data supply chain.

Much of the setup and configuration of data trading for a data supply chain can be developed by using a browser-like GUI provided by a block chain infrastructure platform. For the Ethereum block chain, the browser like interface is called “Mist.” These GUI's can be readily applied to the generation of Smart Contracts.

The invention disclosed herein is a system and method to monetize data transactions. These are the options for monetization enabled through the invention:
Monetization per DIP within a dataset
Monetization per change to a value component associated with a DIP
Monetization per contract/agreement between a data buyer and a data producer
Monetization per registration of a data producer into a data buying process
Monetization per connection of a data buyer into a data seller's process for
distributing DIPs
Monetization per click on a field within a GUI involving DIPs
Monetization per message distributed using the messaging capability of the block chain infrastructure
Monetization per download of any of the API's that enable the data supply chain
Monetization by subscription to each of the API's or a combination of the API's that enable the data supply chain

In all instances of monetization, the unique advantage of the use of block chain infrastructure is its ready adaptability to micro-payments and micro-fees. Before micro-payments and micro-fees via a block chain were enabled, a marketplace for monetization of data by the DIP and changes to DIPs was not feasible due to the inefficiencies and add-on fees of the centralized data exchanges where the transactional costs of the “middle-man” meant that data had to be traded in larger datasets. Additionally, the peer to peer network and redundancy of a block chain infrastructure is perhaps even friendlier to micro transactions than to large macro transactions. Another advantage of the block chain is its intrinsic respect and protection of data privacy and for rigorous auditing and validation of contracts. Simply put, without a block chain infrastructure, a data trading platform by the individual DIP or by the change to a DIP would be possible, but not practical, because the incentive to trade provided by monetization would be made moot by fees and other impediments to transactions on a micro level.

As technical improvements are made to block chain infrastructure and the development of smart contracts that interact with a block chain, a person of ordinary skill in the art will evolve embodiments of the invention to leverage those improvements. It is expected that memory limitations on the block chain will be resolved to some extent and that latency periods between postings to the ledger and validation and authentication will be reduced as well. The value of data is time sensitive, and data is most valuable when it changes. The closer the block chain can get to real time implementation of the data supply chain and the systems and methods of this invention, the more valuable and far reaching are its implications.

In an earlier patent U.S. Pat. No. 7,860,760, the inventor coined the term “data supply chain” to help those with fiduciary roles or interests within businesses or organizations to view the management of their data as a cost center subject to pricing schedules and planning. The method and system of the invention described herein will further reduce the data buyer's risk of getting unstructured data or insufficient data or too much data. The data producer is similarly assured that compensation for the use of their back end database structure; the software to capture data and report it; and the cost of the website and other infrastructure to house the database and provide access to it is included into the terms of the Smart Contract mutually agreed by the seller and the buyer. Notification of fees and other transactions further enable a win-win relationship between the data buyer and the data producer.

An analogy of the business method as implemented by the system of the invention is to consider the Smart Contract as the “controller,” the block chain infrastructure as the “motor,” and a change to a value component for a DIP by a data producer or producer or electronic devices of the data producer as the fuel that provides the energy to the motor.

### BRIEF DESCRIPTION OF THE DRAWINGS

Other aspects, features, and advantages of the present invention will become more fully apparent from the following detailed description, the appended claims, and the accompanying drawing in which:

FIG. 1 is a block diagram illustrating various components in accordance with one embodiment of the present invention focusing on API's and Dapp's.

FIG. 2 shows a flow diagram representing exemplary processing implementing the invention focused on the relationships between devices of data producers, data buyers and the block chain.

FIG. 3 diagrams the method steps and processes to build and implement a Smart Contract for changes in values of a DIP.

### DETAILED DESCRIPTION OF THE DRAWINGS AND HOW THEY EMBODY THE INVENTION

### Definitions

For purposes of clarity in this relatively new discipline within electronic commerce; perhaps most closely related to USPTO art group 3625, the following definitions of terms for this invention are offered. The definitions are by no means exhaustive, but will enable the examination process for this and other art related to the block chain to evolve appropriate and consistent definitions and terms.

DIP—(as in U.S. Pat. No. 8,862,506) necessary and sufficient identifying information coupled with a question and an answer, the answer being the value component inserted at the intersection of a row and column in a tabular data set. While the row and column labels and the necessary and sufficient identifying information is constant for a given DIP, the value component is not. The entire DIP with the change in the value component is the necessary and sufficient monetize able unit a data producer sells and a data buyer purchases. The term “DIP” is closely related to a “datum,” a term that describes a single piece of information.

Data buyer—an entity that purchases a dataset of a series of DIPs and at least one change in the value component associated with a DIP.

Data producer—an entity that posts changes to a value component associated with a DIP. Data producers may be individuals who post changes in to value components associated with a DIP as well as devices participating in the internet of things that transmit changes to data as they occur in real time or are registered as changes via scheduled scans and other actions performed by the devices in the course of their operation. Examples of data producers are scientific researchers, detection equipment and sensors, transaction registers like ATM's, card readers, and so forth.

Dapp (largely taken directly from an Ethereum blog post by Stephen Tual). This is a decentralized application that consists of two parts: a frontend, written in HTML or QML, and a backend or data set linked to the frontend.

The frontends of Dapps have full network access, and CDNs are accessible. Developing a frontend for a Dapp written HTML is similar to developing a website that can enable reactive programming through callback functions.

Because the block chain infrastructure—(in this case Ethereum) relies on cryptographic principles to function, every Dapp knows the pseudonymous identity of each user, thus bypassing a need for ‘accounts’ or ‘logons’, functioning like openID by default, everywhere.”

The block chain infrastructure enables backend operations to be validated by all nodes on the network, meaning that a backend will always will do what its code says it does.

Prepared data—data a data producer configures to meet the criteria of a data buyer, such as the labels for a rows and columns and the format for the value component entered for a DIP. An examples of prepared data is a Column labelled “A” (any term), a row labelled “B” (any term that is not A) and a value component that is often related to a measurement, but may also be any term that changes as data is accumulated about it. Values of value components will commonly be in a numerical form, but can vary according the measurement criteria. Art for associating value components with their data item pair is commonly reflected by survey research tools and other research protocols. A value component can represented by any alphanumeric text, including Boolean indicators and scaled markers.

Data supply chain—The set of data producers and data buyers who trade or exchange a common set of DIPs, usually for micro-fees. Usually there is a mechanism for both data producers and data buyers to join a data supply chain and identify the DIPs they are willing to insert into the data supply chain. Devices of data producers and data buyers are commonly linked together for real time streaming and transfer of data. A feature of a data supply chain that offers a unique advantage is that disparate data producers can feed DIPs to a data buyer. The data buyer can bypass traditional data analytics and, instead, evolve formulas and triggers to be applied to data as it is streamed to the data buyer to automate further server actions and notifications when threshold values for the triggers are attained. The data supply chain has been called “an engine to leverage distributed ‘small’ data.”

Block chain (derived from the en.bitcoin.it.wiki) “A block chain is a transaction database shared by all nodes participating in a system based on the original Bitcoin protocol. A full copy of a block chain contains every transaction ever executed on the chain. With this information, one can find out how much value belonged to each address at any point in history.

Every block contains a hash of the previous block. This has the effect of creating a chain of blocks from the genesis block to the current block. Each block is guaranteed to come after the previous block chronologically because the previous block's hash would otherwise not be known. Each block is also computationally impractical to modify once it has been in the chain for a while because every block after it would also have to be regenerated. These properties are what make double-entries of transactions very difficult.

Generators of a new block build onto an existing block by referencing it in the block they generate and the block they reference must be the latest block in the longest valid chain. A chain is valid if all of the blocks and transactions within it are valid, and only if it starts with the genesis block.

For any block on the chain, there is only one path to the genesis block. Coming from the genesis block, however, there can be forks. One-block forks are created from time to time when two blocks are created just a few seconds apart. When that happens, generating nodes build onto whichever one of the blocks they received first. Whichever block ends up being included in the next block becomes part of the main chain because that chain is longer. More serious forks have occurred after fixing bugs that required backward-incompatible changes.

Blocks in shorter chains (or invalid chains) are not used for anything. When the bitcoin client switches to another, longer chain, all valid transactions of the blocks inside the shorter chain are re-added to the pool of queued transactions and will be included in another block. The reward for the blocks on the shorter chain will not be present in the longest chain, so they will be practically lost, which is why a network-enforced 100-block maturation time for generations exists.

Because a block can only reference one previous block, it is impossible for two forked chains to merge.

Block chain ledger—a ledger replicated on multiple devices with persistent memory storage through a peer to peer network where each posting to the ledger is subjected to verification and authentication by users of the block chain according to configurable criteria set by the users or administrators of the block chain. Commonly 51% of the users who access a given posting and do not object to it will satisfy the transactional rules for the posting to be implemented. The transactional rules are embodied in smart (mini-computer programs) contracts. Postings carry Public keys of the users of the block chain. The private keys of the users of the block chain are linked to the public keys, but remain off the block chain ledger and are known only to the holder of the private key.

Smart contracts—(from Wikiwand.com) “computer protocols that facilitate, verify, or enforce the negotiation or performance of a contract, or that obviate the need for a contractual clause. Smart contracts usually also have a user interface and often emulate the logic of contractual clauses. Proponents of Smart Contracts claim that many kinds of contractual clauses may thus be made partially or fully self-executing, self-enforcing, or both. Smart contracts aim to provide security superior to traditional contract law and to reduce other transaction costs associated with contracting.”

Privacy—(from Wikiwand.com) “Privacy concerns exist wherever personally identifiable information or other sensitive information is collected and stored—in digital form or otherwise. Improper or non-existent disclosure control can be the root cause for privacy issues. Data privacy issues can arise in response to information from a wide range of sources, such as:
Healthcare records
Criminal justice investigations and proceedings
Financial institutions and transactions
Biological traits, such as genetic material
Residence and geographic records
Ethnicity
Privacy breach
Location-based service and geolocation

The challenge in data privacy is to share data while protecting personally identifiable information. The fields of data security and information security design and utilize software, hardware and human resources to address this issue.

Encrypted keys are often used to increase the likelihood data will remain ‘private’.”

Public and private encrypted keys—(from Wikiwand.com) “It is computationally easy for a user to generate a public and private key-pair and to use it for encryption and decryption. The strength lies in the “impossibility” (computational impracticality) for a properly generated private key to be determined from its corresponding public key. Thus the public key may be published without compromising security. Security depends only on keeping the private key private.

Public key algorithms, unlike symmetric key algorithms, do not require a secure channel for the initial exchange of one (or more) secret keys between the parties.

Because of the computational complexity of asymmetrical encryption, it is typically used only to transfer a symmetrical encryption key by which the message (and usually the entire conversation) is encrypted. The symmetrical encryption/decryption is based on simpler algorithms and is much faster.

Message authentication involves hashing the message to produce a “digest,” and encrypting the digest with the private key to produce a digital signature. Thereafter anyone can verify this signature by (1) computing the hash of the message, (2) decrypting the signature with the signer's public key, and (3) comparing the computed digest with the decrypted digest. Equality between the digests confirms the message is unmodified since it was signed, and that the signer, and no one else, intentionally performed the signature operation—presuming the signer's private key has remained secret to the signer.

Widget—(from Wikiwand.com) “downloadable applications which look and act like traditional apps but are implemented using web technologies including JavaScript, Flash, HTML and CSS. Widgets use and depend on web APIs exposed either by the browser or by a widget engine . . . ”

A typical embodiment enables a data producer to monetize at least one change to data linked to a peer to peer network having a block chain infrastructure provided the data producer has linked at least one Smart Contract to enable postings to a block chain infrastructure. The data producer prepares data for posting to the ledger of a block chain according to terms and specifications of a Smart Contract. Data is typically posted by code activation within the Smart Contract in real time as the data changes on an electronic device accessible to the data producer and the Smart Contract. Activating the Smart Contract generates and encodes the encrypted key of the data producer and encodes the changed data into the key.

Another operation within a Smart Contract, or an operation enabled by a separate Smart Contract, posts samples of prepared data that can be accessed via the block chain ledger by a prospective data buyer using an encrypted key accessible to the prospective data buyer. Included into a Smart Contract are terms for pricing and fees for one or more changes to the prepared data, computer readable instructions for utilizing the block chain to implement digital currency transactions according the pricing or fee terms, and computer readable instructions for generating a message or series of messages regarding the transaction from a data producer to a data buyer and vice versa. The data producer and the data buyer both have unique encrypted keys.

Also included and encoded into a Smart Contract are computer readable instructions to post one or more changes to the prepared data to the public ledger of the block chain. In order to facilitate agreement to sell changes to data, actual data of a data producer is anonymized prior to exposure to a prospective data buyer. The data buyer then evaluates the anonymized data and offers a price or fee a change to a value component of at least one DIP in the anonymized exposed samples of the prepared data.

In a typical embodiment a key is generated by the data producer invoking the Smart Contract to automate a post a sample of prepared data of a data producer to the public ledger of the block chain for any prospective data buyer to view. In a variant of the typical embodiment an encrypted key is shared with a prospective data buyer via the block chain. The prospective data buyer then uses the key to link to and view a confidential sample of prepared data external to the block chain. Another variant is a data producer posting onto a web page or other internet enabled display a sample of the prepared data for a prospective data buyer to evaluate along with the data producer's contact information. Yet another variant is for a data producer to expose or post anonymized data to a search engine Prepared data, whether embedded into an encrypted key on the block chain or linked via a key readable on the block chain to link to a post of the prepared data external to the block chain, includes options for the prospective data buyer to select demographic and other information to be included into encrypted keys by the data producer via activation of a Smart Contract along with at least one change to at least one value component of a DIP included into the agreement for sale of the data by the data producer to the data buyer.

A typical embodiment also can be driven by the data buyer. In this embodiment the data buyer provides a data producer a computer readable program, an API, a smart QR code, or a smart RFID tag to link the data producer to a Smart Contract. Typically this occurs at a point of payment for at least one of a product, a service, and an information resource. The link enables the data producer to install and activate the Smart Contract provided by the data buyer upon at least one processor on at least one electronic device of the data producer. Smart contract terms in some embodiments include permission to decrypt data if the data is held by a third party.

Block chain infrastructure and Smart Contracts can be developed and applied in a variety of way to facilitate an open market for data, always including use of the public ledger of the block chain infrastructure to verify and authenticate transactions. An example is an embodiment that is directly converts a posted change of a value component of a DIP as prescribed by a Smart Contract into a unit of digital currency.

An embodiment can use a block chain to build a digital currency infrastructure in which a Smart Contract is used to establish parameters for and create links to a data producer's data set, a data producer's digital address, a DIP within the data set, a format for the value of a DIP value component, and a link to a data buyer's digital address.

Embodiment that leverage the block chain will enable an electronic device to be configured to hash at least one DIP or data field with a value component associated with the data field to link to a data producer's digital address; configure an electronic device to encode and decode the DIP and the value component into a format that enables transactions to be processed according to terms of a Smart Contract; configure an electronic device to enable queries of data to be performed on it according to terms of a Smart Contract, and configure an electronic device to enable messaging regarding transactions according to terms of a Smart Contract. Embodiments can include one device or several devices into the configuration schema.

One device associated with an embodiment will host a computer-readable storage medium housing an executable program for the program to instruct linked devices to access a system having a block chain infrastructure to create at least one data producer address and at least one buyer address, prepare changed data upon said one or more electronic devices for transfer according to terms of at least one Smart Contract, and transfer the changed data to a block chain infrastructure while retaining links between the data, the data producer address, and the buyer address. Encrypted keys in embodiments as generated by Smart Contracts will carry necessary and sufficient information for all users of the business system and method to perform their functions in the transactional schema of the invention. The executable program will also enable a user of the business system and method to use the block chain infrastructure to implement digital currency transactions and distribute messages according to terms explicated in a Smart Contracts. In some embodiments, the user of the executable program will be enabled to transfer fees and funds to a third party. In some embodiments, the user of the executable program will be enabled to halt implementation of a current Smart Contract and reconfigure the terms of the Smart Contract for a data buyer to accept or reject.

Data supply chains can provide significant benefits to charitable and non-governmental organizations. Some embodiments of the invention are intended to be implemented as a public service when a data producer designates an entity to be the beneficiary of a Smart Contract that links a data set and the changes to value components of DIPs.

Embodiments of the invention for data supply chains that use block chain infrastructure enable the owner of devices to use the internet of things to post changes to values of DIPs to the block chain. Wi-Fi chip sets, such as the esp8266, enable an owner of any electronic equipment or appliance to use a simple interface to configure the chip sets to link an electronic sensor, appliance, or device into the IoT by attaching a Wi-Fi chip set to it. When a Wi-Fi chipset is folded into the invention, a local device with data storage and processing capability accepts transmissions from the connected electronic equipment or appliance of DIPs and changes to DIPs. The data storage and data processing enabled device, if linked to a Smart Contract via a Dapp, implements terms of the Smart Contract and monetizes the data supply chain.

If an owner of IoT devices and devices enabled to perform as IoT devices attaches and connects a Wi-Fi chip set to link via a Wi-Fi transmission protocol to at least a host device, a data producer can implement a smart contract with a data buyer by transmitting data to be posted into the block chain ledger. The process is automated and invokes the smart contract and implements its terms. In effect, this is M2M monetization. The device owner's host processor can tag transmission of data from the IoT device in real time and the messaging and payment terms in the smart contract can be implemented, even running in background.

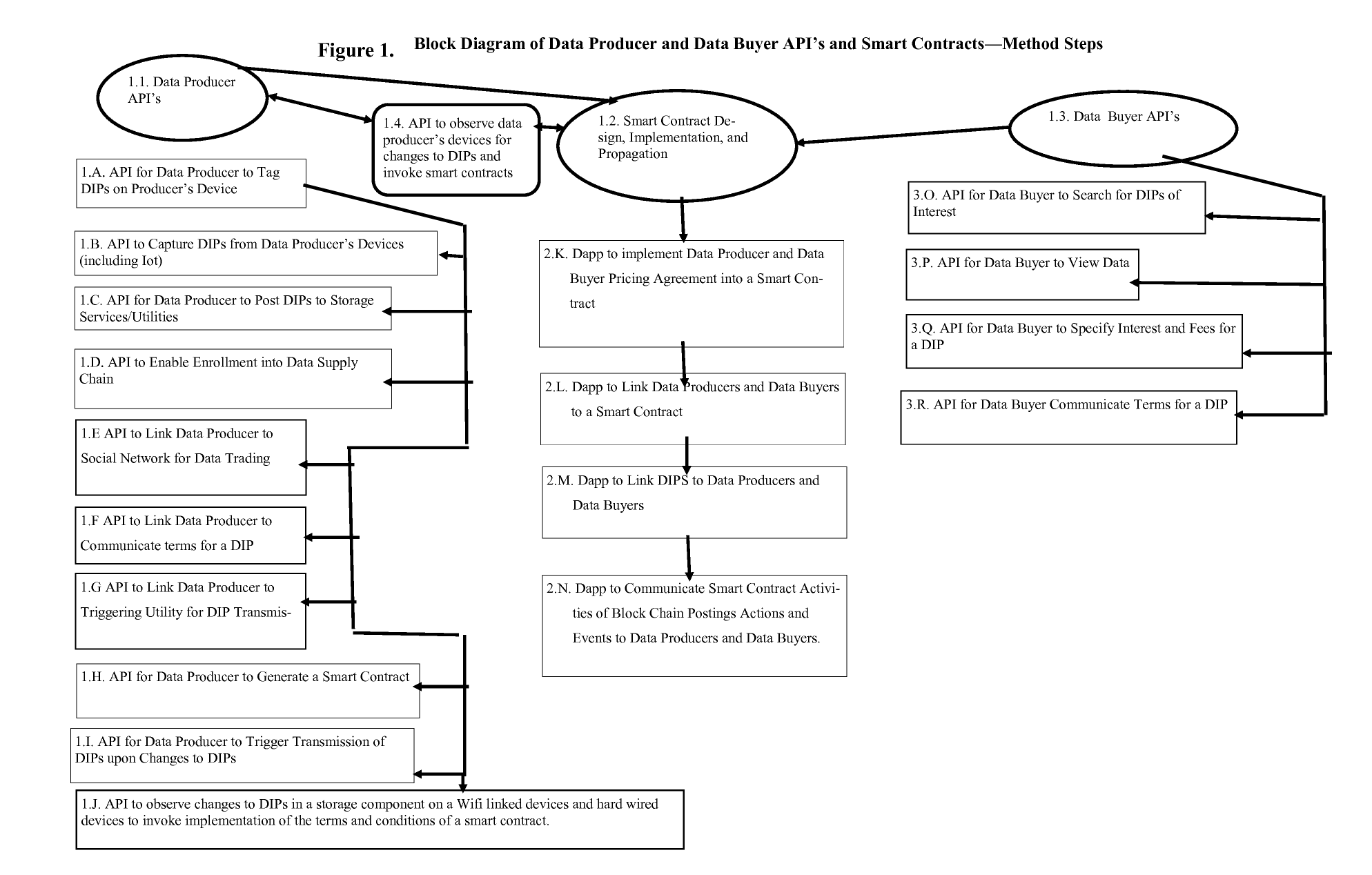

FIG. 1 is a block diagram of a data producer and a data buyer using API's and Smart Contracts to implement method steps of the invention.

The first oval (FIG. 1.1) illustrates the method of the invention using a block diagram focused on data producer API's. These API's will interaction with the FIG. 1.2 oval focused on Smart Contracts. The FIG. 1.3 oval is focused on API's of the data buyer. API's are labelled with a letter to tag them to a descriptor of their functions and outputs. Embodiments can use all of the API's or just some of them. The API's can also be linked together by additional code or integrated with one another into a larger body of code. It is expected that API's that implement the embodiments will vary according to the terms of the Smart Contract. Some API's will be more crucial or central to operation of the method. The group of API's labelled in FIG. 1.1 and FIG. 1.3, while not necessarily exhaustive, will be included into most embodiments.
1.A. API for data producers to tag DIPs on a producer's device.
1.B. API to capture changes to DIPs from a data producer's devices, appliances, and equipment (including lot).
1.C. API for a data producer to post changes to DIPs to storage services and utilities.
1.D. API to enable enrollment of both data producers and data buyers into a data supply chain.
1.E. API to link a data producer to a social network for communicating with members of the social network regarding data available for trading and data members of the network desire to be captured and traded.
1.F. API to link a data producer to a communication method such as email, or instant messaging or the messaging services offered via a block chain infrastructure to communicate terms for trading a change to a DIP.
1.G. API to link a data producer to a triggering utility to initiate transmission of changes to a DIP and posting of the changed value of the DIP to a block chain infrastructure in accordance with a Smart Contract. The triggering utility customarily includes a formula builder and a method to identify fields within a dataset to include into one or more formulas. The utility also may include methods to link datasets together for more complex formula building. While a given device, such as an IoT device will generate a change to DIP as a single unit without the DIP necessarily being associated with a dataset, many data producers will have devices or possess the ability to identify or generate multiple changes to data items to load into datasets that can be used as components of a triggering formula and thus multiple changes to a DIP. When the triggering formula of the triggering utility is activated, there is a high probability a change in a DIP or a change in a series of DIPs will be generated.
1.H. API for a data producer to generate a Smart Contract. There are already a multiplicity of Smart Contract generation utilities and any of these can be provided to a data producer to establish his Smart Contract.
1.IAPI for a data producer to trigger transmission of changes to DIPs without invoking or using a triggering utility,
1.J. API to observe changes to DIPs in a storage component on Wi-Fi linked devices and hard wired devices to invoke implementation of the terms and conditions of a Smart Contract without the intermediation of a data producer or other devices of a data producer. This direct transmission and posting of the change to a DIP to the block chain infrastructure will, in some instances even bypass the need for a storage component. Periodic or scheduled or triggering criteria built into an IoT device or an electronic device with a Wi-Fi chip set in these cases can be automated.

FIG. 1.2 oval for is Smart Contract design, implementation, and propagation. The oval is simply to indicate that K-N are part of the process for Dapps. A Dapp is an application specifically designed to interact with a block chain infrastructure and fold these into and generate Smart Contracts. Dapps and Smart Contracts are integral to one another. A Dapp specifies in computer readable form the relationship and of a data producer and a data buyer using the block chain infrastructure as the intermediary.
2.A. Dapp to implement data producer and data buyer pricing agreements into a Smart Contract.
2.B. Dapp to link data producers and data buyers to a Smart Contract.
2.C, Dapp to link DIPS and changes to DIPs to data producers and data buyers.
2.D. Dapp to communicate Smart Contract activities of block chain postings, actions, and events to data producers and data buyers.

FIG. 1.3 illustrates API's commonly used in embodiments by the Data Buyer;
3.A. API for Data Buyer to Search for DIPs of Interest
3.B. API for Data Buyer to View Data
3.C. API for Data Buyer to Specify Interest and Fees for changes to a DIP
3.D. API for Data Buyer Communicate Terms for changes to a DIP

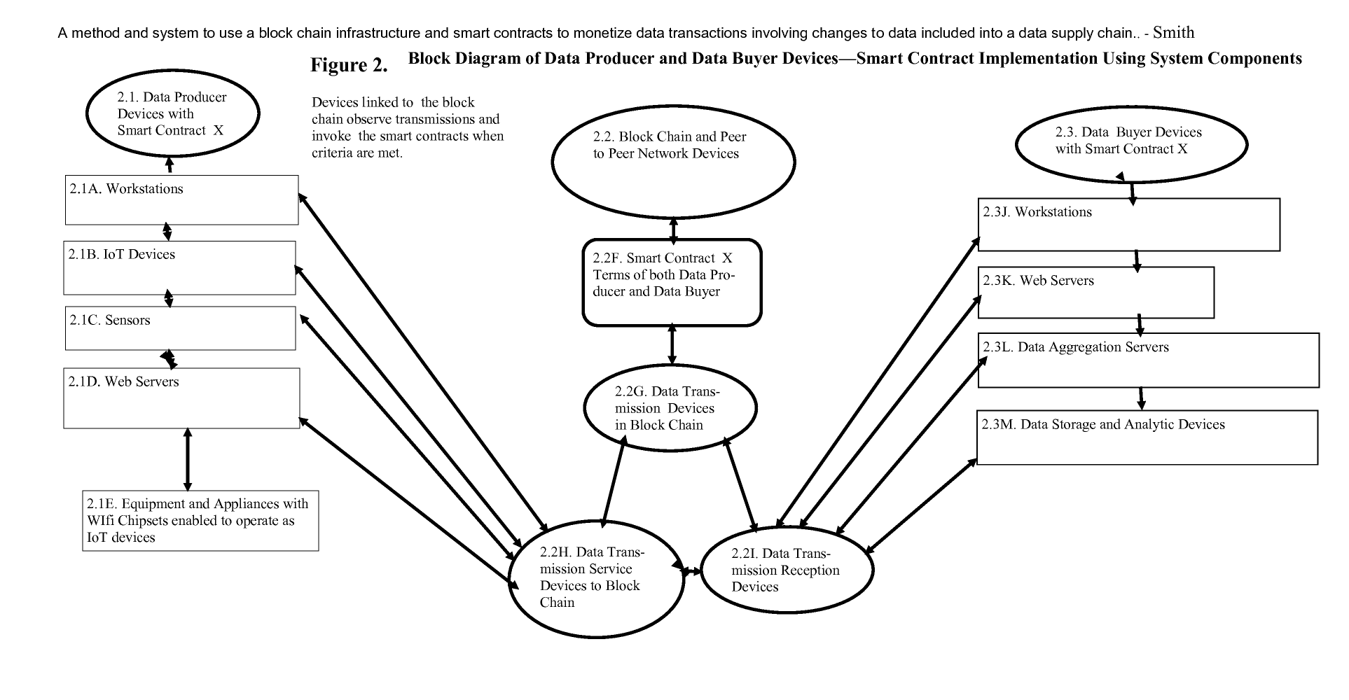

The rounded rectangle in FIG. 1.4 is for an API that functions differently from the other API's of a data producer because it links to the implementation of the Smart Contract and use of the block chain infrastructure. The arrows for the other API's associated with the FIG. 1.1 oval are not necessarily linked externally to the data producer or his devices. Also the API's linked to the oval of FIG. 1.3 are associated with the data buyer and his functions for his devices.
FIG. 2. is a block diagram of the system involving data producer and data buyer devices focused on smart contract implementation using data producer and data buyer devices. Devices linked to the block chain observe transmissions and invoke the Smart Contracts when criteria within the transmission are met.
The first oval, FIG. 2.1, represents the data producer's set of devices associated with a smart contract (called “X”). The second oval, FIG. 2.2, represents the block chain infrastructure and the network of peer to peer linked devices that implement the block chain. The third oval, FIG. 2.3 represents the set of devices associated with a data buyer and linked to the same contract as the data producer (called “X”).
FIG. 2.1 shows the data producer devices with a smart contract and their relationships. Representative devices are:
2.1A. Workstations
2.1B. IoT devices
2.1C. Sensors
2.1D. Web servers
2.1 E. Equipment and appliances with Wi-Fi chipsets

FIG. 2.2 shows the block chain and peer to peer network devices linked to the block chain in which the smart contract is treated as a component that directs transmission to the block chain and between data producers and data buyers. Representative transmissions are:
2.2F. Device hosting a smart contract observes transmissions
2.2G. Data transmission devices connected to the block chain
2.2H. Data transmission services connected to devices linked to the block chain
2.21. Data transmission and reception devices linked to a data producer or a data buyer

FIG. 2.3 shows how the data buyer's devices operate as mediated through a smart contract:
2.3J. Workstations
2.3K. Web servers
2.3L. Data aggregation servers
2.3M. Data storage and analytic devices

A note on FIG. 2 explains that devices linked to the block chain observe transmissions and invoke the smart contracts when criteria are met.

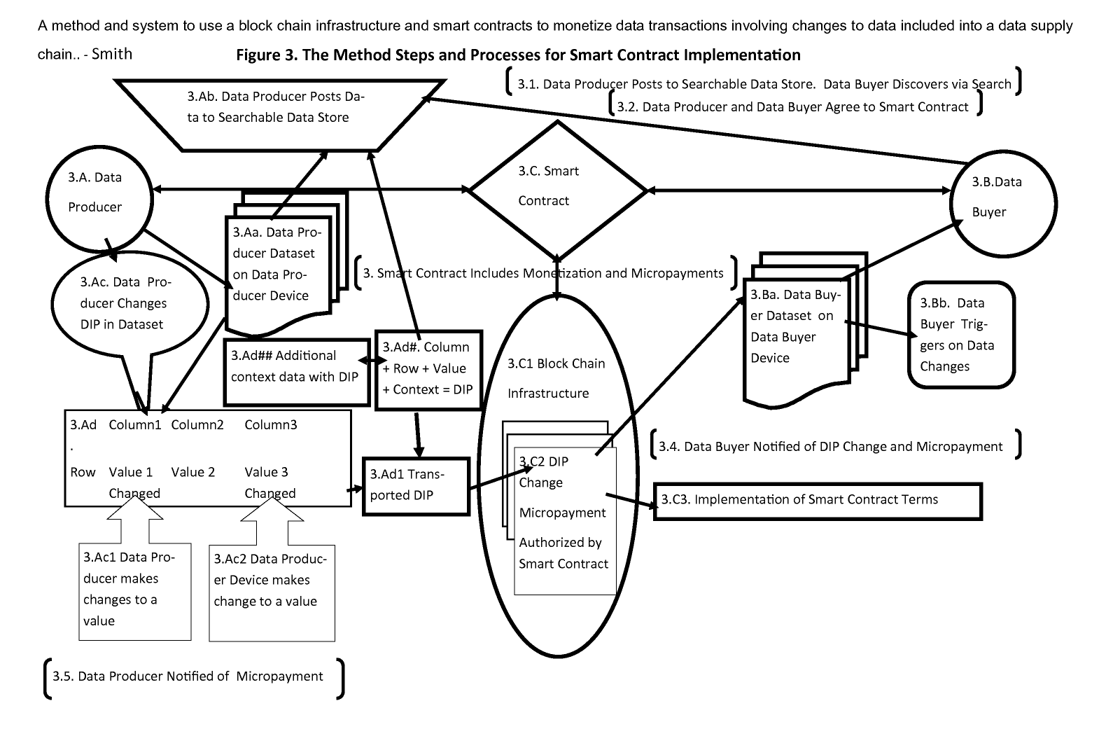

Method steps and processes for Smart Contract design, negotiation and implementation is illustrated in FIG. 3. The first stage illustrated by 3.1 is for the data producer to enable discovery of data he is willing to trade and to update. To enable this, the producer posts the dataset, or at minimum a description of the dataset to a searchable data store discoverable via a web search or by common active marketing activities, such as email messages to targeted potential data buyers, advertisements, and so forth. Those skilled in marketing will use tools available to marketers. The data buyer will typically discover a dataset of interest to him via search, but those skilled in the art will use business to business and other methods to inform both parties that there is a dataset that may be of interest. The stage for 3.2 is for the data producer and data buyer to agree to terms for a smart contract. In stage 3.2 the data items, the kinds of changes to data items, the scheduling of transmissions upon changes, and other operational choices are made and agreed to. In stage 3.3 the financial portion of the smart contract is determined. The data producer and data buyer agree to fees and prices and payment terms for the originating dataset itself as well as for the changes to values of data items to be posted to the block chain infrastructure by the data producer. Micropayments, digital and hard currency transactions, and other payment or reward methods for the dataset and the changes in values of data items are folded into the smart contract. In stage 3.4 the data buyer is notified of pending transmission and consequent transactions and will, in some embodiments, be given an opportunity to interrupt the implementation of the smart contract, renegotiate the terms of the contract, and discontinue the contract. In stage 3.5, the data producer is notified of payments and micropayment and, in some embodiments, is enabled to renegotiate the terms of the smart contract.

FIG. 3.A focuses on the actions and processes implemented by the data producer. 3.Aa is the data producer identifying the dataset for inclusion into the data supply chain. 3.Ab is the data producer posting data samples, descriptions, to a searchable data store for evaluation by a prospective data buyer. A variety of methods to communicate the structure and content of the data will be accessible to a data producer in embodiments constructed and configured by those skilled in the art of data display and characterization.

When the data producer engages with a dataset, as in 3Ac, the engagement typically takes two forms. In 3Ac.1 the data producer manually changes a value associated with a DIP in a dataset. This kind of activity is common where the data producer is a researcher or manages data entry into documents forms and tables in the course of doing business. In some business processes, manual or human initiation of data entry is still performed, such as inventory managers and customer service representatives updating files. Embodiments including these business methods will commonly use a triggering formula to evaluate when a change to a DIP to be traded is made and thus initiate transmission in accordance with the smart contract's terms. In 3Ac.2 a device or sensor makes a change to a value.

3.Ad addresses the data table itself. To illustrate the package of data posted to the block chain, 3.Ad includes the typical structure of a DIP in a typical embodiment; 3Ad# shows how the column label and the row label and the value where the row and column intersect; 3.Ad## shows the additional context for the DIP, such as the demographic identifiers; and 3Ad### shows the context of the dataset the DIP is extracted from. 3.Ad and the context are configured according to the smart contract. A person of ordinary skill in the art will readily understand that variations of embodiments will includes more or less demographic and other identifying information to post to the block chain ledger. The context of the DIP is included with a value change and is encoded into the encryption key transmitted to the block chain infrastructure. Context is variable, but in all embodiments will carry necessary and sufficient information about the table to enable the key, upon decryption, to point to a particular data item referenced in a smart contract and common to both the data producer and the data buyer. 3Ad.1 shows the transported change to a value associated with a DIP.

3B. illustrates the data buyer's participation in the process. In 3Ba the data buyer links data on the data buyer's device to a DIP identified in a smart contract. In 3Bb, computer readable code on the device of the data buyer “reads” the encrypted key with the data value changes in the DIP and posts them into the relevant data table of the data buyer and the device of the data buyer initiates or triggers server actions and events upon confirmation of changes to data values for DIPs of the data buyer. The server actions and events include enabling financial exchanges and other actions according to the terms of the smart contract.

3C. illustrates how the smart contract generated by a data producer and data buyer is folded into 3C.1 the block chain infrastructure to enable 3C.2 micro payment for a change to a value of a DIP authorized by a smart contract and 3C.3 implementation of other smart contract terms

It will be evident to those of ordinary skill in the art of the invention that variation in embodiments will be common. The essential processes and methods and use of a system of devices will, however, be common to all embodiments. Integration of smart contracts and block chain infrastructure is in its early stages as is the IoT. The data supply chain is also in early stages. The art explicated herein to combine the immediate real time benefit in risk reduction and opportunity identification of the data supply chain with smart contracts using block chain infrastructure for micropayment via digital currencies creates an opportunity for a new class of business methods. This new class will offer significant benefits in enabling the maintenance of privacy of personal information while giving access to actionable data and implementing a fair and transparent market for data producers and data buyers to use redundant distributed ledgers of transactions on peer to peer networks for their individual and social purposes.

1. A method and system for a data producer to utilize a block chain infrastructure to monetize at least one change to a value of at least one data item;
wherein said data producer links at least one smart contract to said block chain infrastructure;
wherein said data producer prepares said at least one change to a value of at least one data item for posting to the ledger of said block chain according to terms and specifications of said smart contract;
wherein said data producer connects at least one electronic device to said block chain infrastructure in real time;
wherein a data buyer accesses said at least one smart contract via an electronic device;
wherein said data buyer endorses terms of said at least one smart contract;
wherein said system links said prepared data item to at least one data buyer; and
wherein said endorsement of said smart contract by said data buyer generates encrypted keys to enable said data producer and said data buyer to utilize said block chain infrastructure to exchange said at least one change to a value of at least one data item.

2. The method of claim 1, wherein said smart contract includes encoding a pricing schedule for said at least one change to said prepared data item, encoding of computer readable instructions for utilizing said block chain to implement digital currency transactions and messaging between said data producer and said data buyer; and encoding of computer readable instructions to post said at least one change to said prepared data to the public ledger of said block chain infrastructure accessible to said data buyer.

3. The method of claim 1, wherein said prepared data item of said data producer is anonymized and exposed to said data buyer for said data buyer to evaluate and negotiate a price for said at least one change to at least one data value of at least one of said data item.;
wherein context information about said data item is anonymized; and
wherein context information regarding the data set containing said data item is anonymized.

4. The method of claim 3, wherein said smart contract generates an encrypted key to link to a view of row and column labels for said prepared data of said data producer; and
wherein use of said key by said data buyer enables said data buyer to view context information of the data set, the data structure, and a sample value for said at least one data item.

5. The method of claim 3, wherein said at least one encrypted key includes contextual and demographic information to associate with said data item and includes at least one change to at least one data value of at least one data item to post to said block chain infrastructure upon linking of said data buyer to said block chain infrastructure.

6. The method of claim 1, wherein said data producer exposes said structure of said at least one data item upon at least one electronic device associated with said data producer to at least one search engine.

7. The method of claim 1, wherein a data buyer develops a smart contract and provides a link to said smart contract to a prospective data producer at a point of purchase of at least one of a product, a service, and an information resource.

8. The method of claim 7, wherein said link includes at least one of a widget housing a computer readable program, an API, a smart QR code, and an RFID tag.

9. The method of claim 7, wherein said data producer activates said link provided by said data buyer and wherein said smart code included with said link enables said data producer to view, endorse, post, install, and activate said smart contract upon at least one processor on at least one electronic device of said data producer.

10. The method of claim 2, wherein said smart contract terms includes permission and keys to enable decryption of said data if said data is held by a third party.

11. The method of claim 2, wherein the public ledger of said block chain infrastructure is used to verify transactions according to said smart contract.

12. The method of claim 1, wherein a data producer generates and posts terms of a smart contract accessible to a data buyer for said data buyer to review, amend, negotiate, and accept.

13. The method of claim 12, wherein said terms of said smart contract undergo successive review and amendment until both of said data producer and said data buyer accept said terms.

14. A system comprising at least one electronic device linked to a block chain infrastructure wherein at least one data producer address is created, one data producer data set is invoked, and a transfer of at least one change to at least one data value for at least one data item is linked to said data producer address; and
wherein at least one data buyer address is created, one data buyer data set is invoked, and a transfer of at least one change to at least one data value for at least one data item links said at least one change from said data producer to at least one data item in said data set of said data buyer.

15. The system as in claim 14, wherein an electronic device is configured to hash at least one data field with a data value to said data producer address;
wherein at least one electronic device is configured to encode and decode said at least one data field with a data value into one or a plurality of formats to enable transactions to be processed according to terms of a smart contract;
wherein at least one electronic device is configured to enable queries of data upon said electronic device according to terms of said smart contract;
wherein at least one electronic device is configured to enable messaging regarding transactions according to terms of said smart contract; and
wherein at least one electronic device is configured to enable posting and implementation of digital currency transactions according to terms of said smart contract.

16. A computer-readable storage medium housing an executable program, wherein said executable program instructs one or more electronic devices:
wherein said executable program enables access to a system having a block chain infrastructure;
wherein said executable program creates at least one data producer address and at least one buyer address;
wherein said executable program accepts at least one change to data upon said one or more electronic devices for transfer according to terms of at least one smart contract; and
wherein said transfer of said changed data to said block chain infrastructure retains links between said data, said data producer address, and said buyer address.

17. The executable program upon at least one of said electronic devices as in claim 14, wherein said electronic device implements digital currency transactions and messaging according to terms explicated in at least one of said smart contracts.

18. The executable program upon said electronic device as in claim 14, wherein said block chain infrastructure is used to distribute messages.

19. The executable program upon said electronic device as in claim 14, wherein said executable program enables terms explicated in said smart contract and said fees for changes to data to be transferred to a third party.

20. The executable program upon said electronic device as in claim 14, wherein said data producer specifies within said smart contract that a link to the originating data set of said changed data is to be used as a public reference of verified transactions on said block chain.

21. The system as in claim 14, wherein one or a plurality of IoT devices and devices enabled to perform as IoT devices by said data producer attaching, inserting, and connecting a Wi-Fi chip set are linked via a Wi-Fi transmission protocol to at least one data item upon at least one electronic device of said data producer;
wherein said device is associated with a data producer;
wherein said data producer has developed a smart contract for data exchange with a data buyer;
wherein a change in the data value of at least one data item embedded in a signal transmitted by said IoT and Wi-Fi enabled IoT device is posted to a data set of a data producer, and
wherein said posting to a data set of said data producer invokes and activates said smart contract. 22. The system as in claim 14, wherein at least one processor of at least one electronic device of said data producer observes in real time the transmission and reception of changes in a data value of at least one data item, transmission of messages from a data buyer, transmission of micropayments, payments in digital currency, payments in hard currency, and allocation of incentives and rewards for posting of changes in a data value of at least one data item to said block chain infrastructure; and
wherein said observing triggers activation of said smart contract and implementation of said terms and conditions of said smart contract until said transmission and reception no longer meet criteria for said activation.
